(19) United States
(12) Patent Application Publication
(10) Pub. No.: US 2008/0271594 A1
(43) Pub. Date: Nov. 6, 2008

(54) Electronic Musical Instrument

(75) Inventor: Harvey W. Starr, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Starr Labs, Inc., San Diego, CA (US)

(21) Appl. No.: 12/115,519

(22) Filed: May 5, 2008

Related U.S. Application Data
(60) Provisional application No. 60/915,912, filed on May 3, 2007.

(51) Int. Cl. G10H 1/34

(52) U.S. Cl. 84/646

(57) ABSTRACT

An electronic musical instrument includes an array of electrical switches (transducers) aligned on the body of the instrument and configured to provide a desired instrument layout, and to provide tactile feedback for playing, while having different playing functions. A suitable material overlying the switch array can provide the physical appearance and configuration for the desired instrument layout. For example, a subset of the array switches can be used for a fretting area, in which the overlay material provides multiple “strings” for fretting, and a different subset of the array switches can be used for a strumming area, in which the overlay material supports a strumming action. If desired, an additional subset of the array switches can be designated for additional effects, such as a sensor area.

### CROSS-REFERENCE TO RELATED APPLICATIONS

This application claims the benefit of U.S. Provisional Patent Application Ser. No. 60/915912 entitled “Electronic Musical Instrument” by Harvey W. Starr filed May 3, 2007. Priority of the filing date is hereby claimed, and the disclosure of the application is hereby incorporated by reference for all purposes.

### BACKGROUND

Electronic musical instruments, such as stringless electronic guitars, are known. See, for example, U.S. Pat. No. 5,398,585 to Harvey W. Starr for “Fingerboard for Musical Instrument” issued Mar. 21, 1995 and U.S. Pat. No. 5,557,057 to Harvey W. Starr for “Electronic Keyboard Instrument” issued Sep. 17, 1996. The disclosures of these patents are incorporated herein for all purposes. Such musical instruments have proven to be quite popular with the public. Even greater acceptance and popularity could be achieved with improved performance, easier playing, and reduced cost.

One aspect of production cost comprises the different switches that are needed to provide the various functions of musical play. On a fretted instrument, for example, one type of switch is used for a fretboard to simulate guitar strings and the like, and another type of switch is used for a soundboard area, for strumming. The fretboard switches are typically arranged in an elongated grid of, for example, six “strings” with a number of “fret” switches per “string”, whereas the soundboard switches are arranged for convenient “strumming” action across an extended area. The different switch types and arrangements can add to production costs. See, for example, U.S. Pat. No. 5,398,585 issued Mar. 21, 1995 to Harvey W. Starr for an electronic musical instrument having a fretboard with multiple switches in an elongated grid.

### SUMMARY

In accordance with the invention, an electronic musical instrument includes an array of electrical switches (transducers) aligned on the body of the instrument and configured to provide a desired instrument layout, and to provide tactile feedback for playing, while having different playing functions. A suitable material overlying the switch array can provide the physical appearance and configuration for the desired instrument layout. For example, a subset of the array switches can be used for a fretting area, in which the overlay material provides multiple “strings” for fretting, and a different subset of the array switches can be used for a strumming area, in which the overlay material supports a strumming action. If desired, an additional subset of the array switches can be designated for additional effects, such as a sensor area.

Other features and advantages of the present invention should be apparent from the following description of the preferred embodiments, which illustrate, by way of example, the principles of the invention.

### BRIEF DESCRIPTION OF THE DRAWINGS

FIG. 1 shows an electronic musical instrument constructed in accordance with the present invention.

FIG. 2 shows construction details for the switch array of the instrument illustrated in FIG. 1.

FIG. 3 shows an instrument with a dual configuration having an electronic area and a stringed area.

FIG. 4 shows construction details of strings that can be provided with the electronic musical instrument of FIG. 3.

FIG. 5 shows construction details of piezoelectric elements for the strings illustrated in FIG. 4.

FIG. 6 shows the electronic instrument constructed in accordance with the present invention with a switch array implemented as a touch-screen area.

FIG. 7 shows an overlay template for use with the touch-screen embodiment of FIG. 6.

FIG. 8 is a block diagram of an electronic musical instrument constructed in accordance with the present invention.

FIG. 9 is a cross-sectional illustration of a portion of the switch array.

### DETAILED DESCRIPTION

In accordance with the invention, an electronic musical instrument can be provided that comprises a MIDI keyboard controller having a guitar-like appearance that is programmable to allow different performance personalities. The term “keyboard” is used herein to indicate that the individual note-positions are programmable as individual elements rather than as a single contiguous and continuous string. Conventionally, a guitar-instrument, or stringed instrument, is thought of as playing only one note, or event, at a time. That is, each string of the instrument can only produce one note at a time. The instrument illustrated herein allows the individual keys in a “string” to be programmed and played independently. In the description herein, references to “Starr Labs” indicate the assignee of the present invention, Starr Labs, Inc., of San Diego, Calif., USA.

The instrument described herein includes an array of keys or switches such that in one designated switch subset, or zone, the designated action that takes place when switches in the designated zone are “played” (pressed or struck) comprises notes being played from a different zone. In that situation, two zones are involved in producing a sound. This novel zone functionality emulates the action of strumming a guitar string. For example, a single switch in a zone can be designated for a strumming action that comprises playing or sounding one or more switches in a different zone to accurately produce the resultant strumming sound. That is, the switches in the multiple zones will have the same construction, but will have different associated actions to be performed, thereby providing different performance personalities. Also, because there are multiple independent keys acting to “strum” or Trigger a given “String”, an extremely facile method of plucking a “string” is supported.

In accordance with the present invention, the “guitar-fingerboard” note layout can be implemented with individual keys or switches that have the option of playing completely independently, or with full polyphony.

Previously known systems typically provided a digital guitar in which each string is comprised of a long, narrow resistive element whose electrical resistance value is determined by the position of a finger at any point along its length. The digitized value of the resistive “string” may be then processed in various ways. Embedded software can create quantized positions along its physical and electrical length for the determination of note positions. This allows the performance of music based on scales with more or less than twelve notes per octave, of arbitrary size and arbitrary pitch relationships. Examples of the different processing that may be generated include:
(1) first touch is quantized, then further positioning slides smoothly;
(2) first touch is quantized, then further positioning is also quantized (chromatic or diatonic);
(3) no quantize at all, and the output response emulates that of a physical string.

Other previous systems have used a linear resistive element to represent each musical string, directly related the “string's” instantaneous resistance to a voltage that adjusted the frequency of a Voltage Controlled Oscillator for sound generation.

In addition to serving as a stand-alone guitar fingerboard emulation, the previously described six-element ribbon-array may be applied as an adjunct to a digital guitar fingerboard such as the Starr Labs fingerboard that embodies a discrete switch for each fingerboard note-location. See the aforementioned U.S. Pat. No. 5,398,585 to H. Starr. In the present application, the six-element ribbon-array may be placed under the fingerboard key-action mechanism in such a way as to provide linear position-sensing information for each string so that a string-player's finger-vibrato expression technique may be realized by modulating the discrete note output with the variable position information.

In accordance with the present invention, a digital guitar-like instrument uses the fretboard as a “right-hand” strumming or Triggering device. Further, by re-programming the fingerboard, other normally-installed expression hardware may be eliminated.

In previous digital guitar-like musical instruments that use individual discrete key-switching to select notes, traditionally a separate transducer array is used to allow emulation of the guitarist's right-hand strumming and picking techniques. The new instrument described herein defines on the fingerboard a rectangular zone of the same fret-keys otherwise used to finger notes that, when tapped, will issue the notes which have been selected by fingering the “fretting” zone(s) of the fingerboard, similar to the action of fretting the notes of a guitar-string and then plucking it to sound the selected notes. For instance, a musical string represented by a row of twenty-four longitudinally-aligned keys may be assigned as four adjacent keys, preferably at the “high” end of the string, that will trigger notes fretted on the other twenty keys. Thus, the elongated trigger bar switches of previous systems for the soundboard area are no longer needed.

When for a given “string” multiple triggering-switches are employed in this way to sound fretted notes, fast fingerstyle or classical guitar techniques may be realized with less training than normally required for mastery using a real acoustic guitar. When multiple trigger-switches are used, they may be visible as discrete key-switches or buried beneath a cosmetic overlay that gives the appearance of a single, long switch.

For the “Ztar Z7S” product from Starr Labs, triggers are implemented on fret-keys assigned to a triggering zone. Any key pressed on a given “string” in the trigger zone will trigger or initiate the corresponding string's notes according to the selected Trigger-modes, such as Guitar, Poly, etc. that define additional performance settings, including hammer-ons, pull-offs, polyphony, muting, and other characteristics. Such triggers are also referred to herein as sensors.

Also, a single key or small zone of keys may be used to trigger notes fingered anywhere on the fingerboard, regardless of whether the triggering keys are aligned longitudinally with the fretted keys as previously described.

Using this triggering-zone design, with the homogeneous switch array described herein, the normally independent triggering transducer hardware may be eliminated to create smaller, lower-cost instruments. As noted below, such trigger functions may comprise, for example, hotkey, sensor, or multi-harp functions.

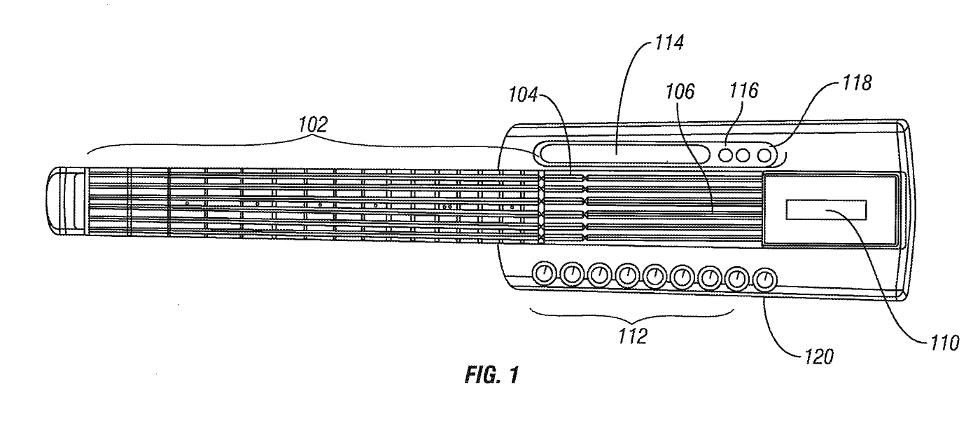

FIG. 1 shows a musical instrument 100 constructed in accordance with the invention. FIG. 1 shows the instrument 100 in the configuration of a guitar, having a guitar body 101 with sensor switches arranged to comprise six rows of sixteen switches comprising a fretting zone 102, a group of six rows of two sensor switches to comprise a sensor zone 104, and a triggering zone 106 comprising a group of six rows of six switches. The illustrated triggering zone includes six rubber bars 108, each of which overlays a group of six of the longitudinally-arrayed triggering zone switches.

FIG. 1 also shows that the instrument 100 includes a user interface display area 110, eight rotary potentiometers 112, a position-sensing ribbon transducer 114, octave up/down keys 116, a “panic button” 118 to interrupt operation when needed, and a rotary encoder/pushbutton switch 120 for operation of the user interface. The encoder/pushbutton 120 can be used to select various control and input options shown on the display area 110, which may be implemented as an LCD screen or the like. All functions, assignments, and operations described herein may be selected via the switch 120 in conjunction with viewing the display area 110. A user may modify instrument operation, such as assign different musical functions to the switches 102, 104, 106, through the control switches 112, 114, 116, 118, 120 in conjunction with the user interface of the display 110.

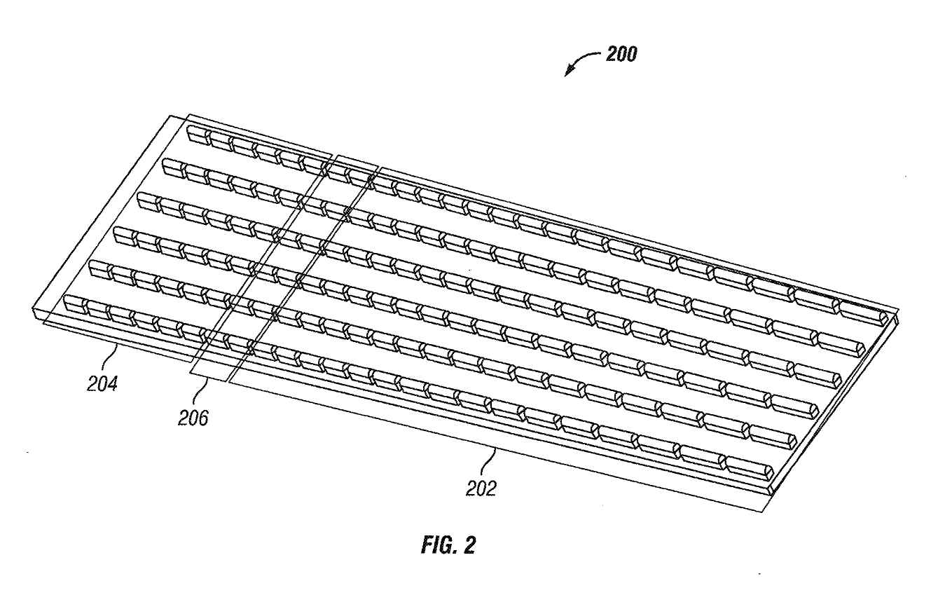

FIG. 2 shows construction details of the switch array 200 comprising the fretting zone 102, fret zone 104, and triggering zone 106. Thus, in FIG. 1 and FIG. 2, the switch array comprises a 6×24 grid of switches. Such a configuration is suitable for a six-string instrument. Different arrays may be used for different configurations. As noted above, a subset of the switch array 200 functions as a 6×16 fretting area, comprising sixteen fret switches arranged into six rows for the six guitar “strings” 102. A subset of the switches is arranged into a 6×2 zone comprising a sensor zone 104. Another subset of the switches is arranged as a 6×6 area for a strumming zone, or trigger zone 106. The grouping into fretting zone 102, sensor zone 104, and strumming zone 106 can be facilitated, in terms of tactile feedback, by an overlay material placed over the switches. For example, a rubber material 202, properly configured and textured, can be extended over the fretting zone 102 to provide frets for “strings”, and another rubber material 204 can be extended over the strumming area 106 to provide easier strumming action. If desired, a further subset, such as the 6×2 fret subset 104, can be provided with an overlay material 206 for a sensor zone or other specialized purpose. For example, the sensor zone switches 104 can be used to initiate sequences, chords, or MIDI functions.

Other features may be provided, as described below.

Hotkey-Zone

In a digital guitar-like instrument such as the Starr Labs “Ztar Z7S” product, an arbitrarily sized block of the fingerboard keys 102, 104, 106 may be defined as a hotkey zone whose purpose is to duplicate the Quick-access function select keys that are normally found on these instruments. These quick-access function keys may then be eliminated to create smaller, lower-cost instruments.

Sensor-Zone

In a digital guitar-like instrument such as the Starr Labs “Ztar Z7S” product, an arbitrarily sized block of the fingerboard keys 102, 104, 106 may be defined as a sensor zone whose purpose is to duplicate the normally found Expression Pads that offer a variety of performance features not ordinarily available to the fingerboard of electronic “stringed” musical instruments. Using the design described herein, the normally found Expression Pads may be eliminated, to create smaller, lower-cost instruments.

Chording Software (Multi-Harp)

Each key of the fingerboard area 102, 104, 106 can be programmed to select a full musical chord. Fretting a single key and strumming or picking the available Triggering hardware will play the notes of a chord as if all the notes were fingered normally with multiple fingers. Thus, multiple chords can be played simultaneously by pressing multiple programmed multi-harp keys. Other single-key chording systems have been made in the past including the Suzuki “Unisynth” product, but those systems did not offer programmability of any sort or the ability to play multiple chords simultaneously.

In addition to ease of playing traditional chords, using this new system, chords may be created and played that are otherwise impossible on a real guitar. The arrangements of an array of chords on the fingerboard are essentially arbitrary but may be organized in several useful ways. The Starr Labs “Ztar Z7S” Multi-Harp software allows the various configurations to be created, stored, and selected dynamically from the instrument.

### EXAMPLES

(1) Chords may be organized along the length of the fingerboard 102, 104, 106 by placing the root-note on the lowest pitched “string”. In this arrangement, chord families may be located on each string on a given “fret”. For instance, the lowest fret might hold across six strings: Fmay, Fma7, Fmi, Fmi6, F7, Faug

(2) Several chords which are required for a given song may be clustered in close proximity, say on a single fret, easing the task of finding needed chords.

(3) Chords may be oriented across the strings partially by root-note and also by family in a 1-4, 1-4, 1-4 relationship, such as: Fma, Bb ma, Fmi, Bb mi, F7, Bb7. This places a few useful families and the most common root-note movement in a tight cluster, allowing an expanded range of musical possibilities in a small space.

(4) Root notes only may be placed on a few strings or just a few keys and musical triads may be placed on a few other strings or keys. The various selected combinations of root notes and triads offer a clear and direct understanding of some of the basic harmonic concepts of western music and jazz in particular.

(5) The multi-harp system further allows several keys to be fingered simultaneously, which then stacks groups of notes or “meta-chords” rather than simply stacking individual notes. This creates a spectrum of harmonies not available to other musical instruments. For instance, just two fingers can elicit a 12-note chord, something done with difficulty using ten fingers on a piano.

(6) An earlier Suzuki “Unisynth” controller offered a single chording map that was fixed and not programmable in any way. Tuned using the bass string as the root-note or Tonic, chords were played ascending F, C, G, D, A, E, B, F#, C#, G#, Eb, Bb in the pre-programmed chord types.

Chord-Creation Features

A root-note, chord-type and starting location may be selected. Selection may be accomplished through the user interface switch 120 in conjunction with the display 110. Chord-types are selected from an embedded list or programmed as musical intervals from the selected root-note. That chord-type is then “cast” up the string by the device software which increments the root-note for successively higher frets. In this way, the electronic musical instrument provides a programmable chord feature.

Chords may also be programmed to individual keys with an arbitrary relationship between chords on adjacent keys. Using this method, all of the chords of a song may be placed in a convenient, compact area or the fingerboard.

Examples of Chord Performance Options:

(1) The chord selected by the fingered key may be strummed guitar-style, so that each chord-note is played by a single plucked String or Key Trigger.

(2) The fingerboard keys may be simply tapped similarly to a normal piano keyboard, and the individual chords may then play with their notes sounding simultaneously as a block chord.

(3) A Fingerboard-Zone may be defined as a Chording-Zone that plays chords in the way described here, while another fingerboard-zone is defined as a Fretting-Zone which is used to play the fingerboard in a more traditional fashion. Combining these two features, one may play simple or complex chords easily while performing essentially normal guitar-style music that employs more single-note lines.

### Arpeggiator

Generically, an arpeggiator is an electronic device or software function that creates multiple notes, correlated by pitch to a given fingered note. It is named as it is because these added notes are usually chordal tones built from the fingered note and played sequentially. In one embodiment, the electronic device described herein provides a stepped arpeggiator.

The Starr Labs stepped arpeggiator of the illustrated embodiment differs from other known arpeggiators in that it does not create any notes other than those that are fingered. Instead, any notes that are fingered or otherwise held sustaining will be included in a stepped-pattern that is repeated in a cycle according to their order of entry. The number of steps in the cycle expands or contracts to accommodate the number of notes held. No notes are added or created by the processor of the instrument in this system. This feature might be more properly described as a real-time entry pattern-sequencer.

The clock-rate that determines the speed of the stepped-pattern is programmable and also controllable in real-time from embedded sensor hardware on the instrument or from a foot-pedal.

Single-Key Re-Trigger

The electronic device provides a user interface with menu screens. With the user interface, a user can enter a “SENSORS>EVENTS” menu screen, where the selected sensing pad, string, or other transducer is assigned as a Single-Key Re-Trigger event with the option to Re-Trigger any or all strings, such as “Strings #1-6”. When this event assignment is created, the user may finger one or more keys on the fingerboard, and when the assigned Re-Trigger sensor is struck, if a single fingerboard key was held, that note will be played. If more than one fingerboard key is held, then all those notes will be played as a chord.

This function provides a simple way to elicit notes in real-time with one finger action without having to learn the complicated right-hand technique of plucking guitar strings. No discrete keys or sequences are stored in memory of the device, but rather the sensor assignment will associate the desired re-trigger action with a single device actuator or sensor.

Thus, as implemented in the guitar-like device described herein, control software is provided that allows a player to finger notes on all the strings of the fingerboard as they would normally, but rather than plucking the individual strings that correspond to the fingered notes, it is only necessary to pluck a single designated string to elicit the notes.

Digital Guitar Fingerboard Design Captures Sideways-Bending Performance Techniques.

On a traditional guitar it is common for a player to stretch a fretted string sideways, normal to the axis of the string, so that the pitch or the vibrating string may be raised or “bent” which adds expression and color to the performance. Guitar-styles such as traditional Blues and Rock depend on this technique. In a digital guitar-like instrument such as the Ztar Z7S or other fingerboard controllers that are essentially specialized keyboard systems, this technique has not before been supported. The new instrument described here adds a circuit pattern to the fingerboard's printed circuit board switching array that is designed to capture sideways pressure applied to each key-switch thereby allowing the resulting variable electrical voltage to be applied to Pitch-bending as well as any other MIDI control function. The device processor adjusts the musical information output in response to the detected sideways pressure applied by a user, such as by adding expression and color to the musical note in accordance with the sideways pressure.

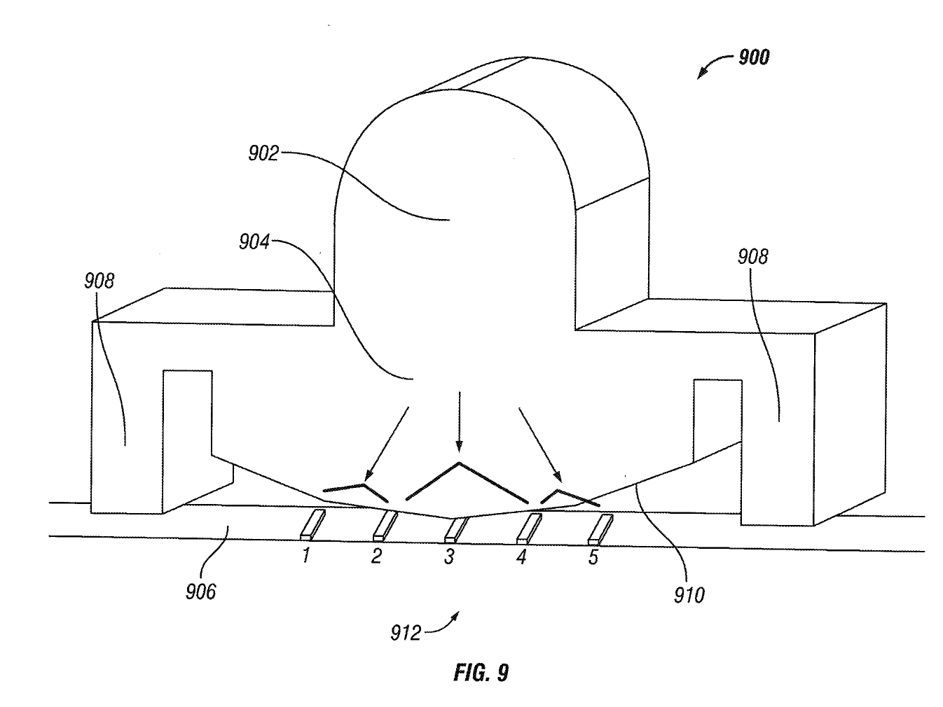

FIG. 9 is a cross-sectional illustration of a key portion 900 with sideways-bending detection. The section illustrated in FIG. 9 is a portion of the overlay, such as illustrated in FIG. 2, cut laterally across the overlay, viewing the overlay along its length. The FIG. 9 section includes a “string” rounded surface 902 on the outwardly facing upper surface of the overlay, with a central body portion 904 supported over an underlying contact circuit board surface 906 having conductive traces identified in FIG. 9 with 1, 2, 3, 4, 5. The switch body 902, 904 portions are supported over the conductive traces of the board 906 by support shoulders 908 of the overlay. The underside of the switch body portions have a curved conductive surface 910.

The conductive traces 2, 4 provide a voltage supply level to switch detection circuitry of the electronic musical instrument. When a user presses down on the overlay, the curved conductive surface 910 bridges contact traces 2 and 3, or 3 and 4, the voltage is applied to the middle trace 3, which causes a key-contact event to be registered with the processor of the instrument. The circuit traces are arranged such that the location of the pressing on the keyboard on the switch array is detected. See, for example, the aforementioned U.S. Pat. No. 5,557,057 for a keyboard polling technique that can be employed.

When a user presses down on the overlay with a sideways bending motion, so that lateral pressure is applied to the “string” surface 902, circuit traces 1 and 2, or traces 4 and 5, are bridged by the curved conductive surface 910 and a sideways-bending event is registered, so that the sideways-bending motion is detected. The processor of the instrument can process the detected sideways-bending event in a different manner from the key-contact event and thereby provide a different sound output in response to the two different playing motions. For example, the processor can be configured to produce a sound from the sideways-bending event that is approximately the same sound that would result from a similar motion on an actual guitar string. Other different sideways-bending processing effects can be provided, as desired.

In FIG. 9, the three sets of arrows and markings bridging the traces 2, 3, 4 and traces 1, 2 and traces 4, 5 are for illustrating the different trace contacts that occur as between vertical pressure (the arrow spanning 2, 3, 4) and sideways bending motion (the arrows spanning 1, 2 and 4, 5).

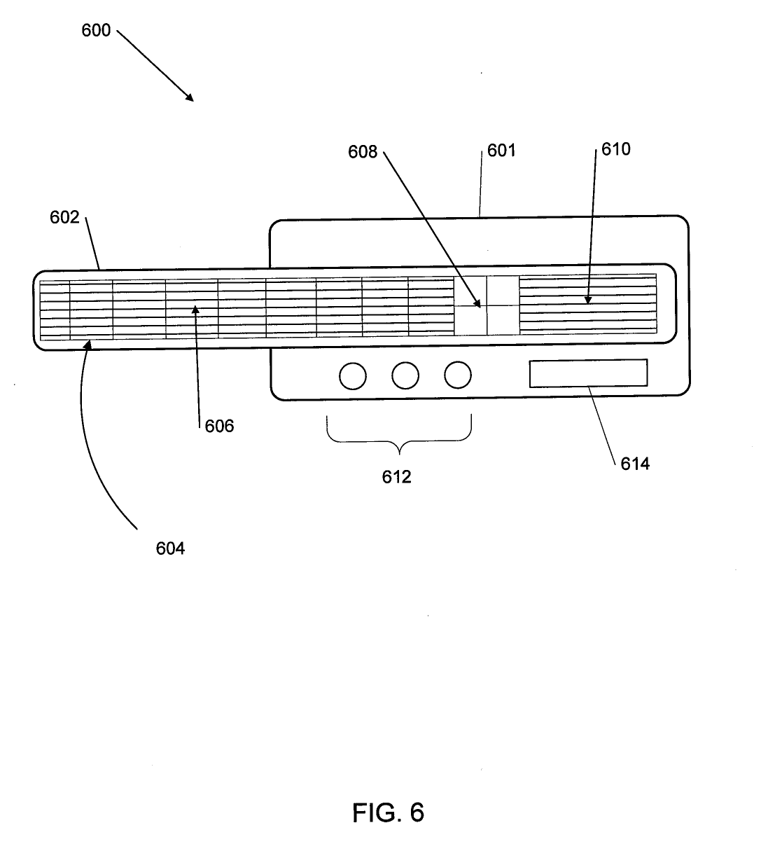

If desired, an overlay or template can be configured for use with a touchscreen panel so that sideways bending motion can be detected. A touchscreen embodiment is described more fully below (see FIG. 6). As with the conductive surface construction, the curved underside of the overlay can be configured so as to register vertical pressure on an overlay “string” differently from sideways bending motion on the overlay. In a touchscreen implementation, the circuit traces 1, 2, 3, 4, 5 illustrated in FIG. 9 are effectively replaced with detection of corresponding portions of the underlying touchscreen. For example, the curved underside of the overlay may be provided with ridges so as to register the underside ridges properly against the touchscreen for differentiating between vertical motion and sideways motion. That is, a 3, 4 contact on the touchscreen must be differentiated from a 4, 5 contact on the touchscreen.

### FEATURES OF THE ILLUSTRATED EMBODIMENTS

In one embodiment, an electronic guitar constructed in accordance with the invention (referred to herein as the “Ztar Z7S Z7” compact MIDI fingerboard controller) can provide many desired features, including those below:

6-string, 16-fret fingerboard

Six (6) Expression Keys (implemented internally as a Sensor-Zone)

Six (6) Trigger Bars (implemented internally as a Trigger-Zone with 6 key-switches per string.

Eight (8) programmable rotary Pots. This has never appeared before on any digital guitar device.

One (1) Multi-function Ribbon controller

One (1) 360-degree Rotary encoder operates the User Interface.

2-row×16-character LCD display

Sustain pedal and Volume pedal ports.

Breath control port.

MIDI and USB communication Ports.

2.4 GHz wireless MIDI link.

Music player (e.g. ipod) docking connector interface.

Optional Full-size Display/programming assembly add-on.

Optional sound card.

### COMBINATION ELECTRONIC TRANSDUCERS AND STRINGS EMBODIMENT

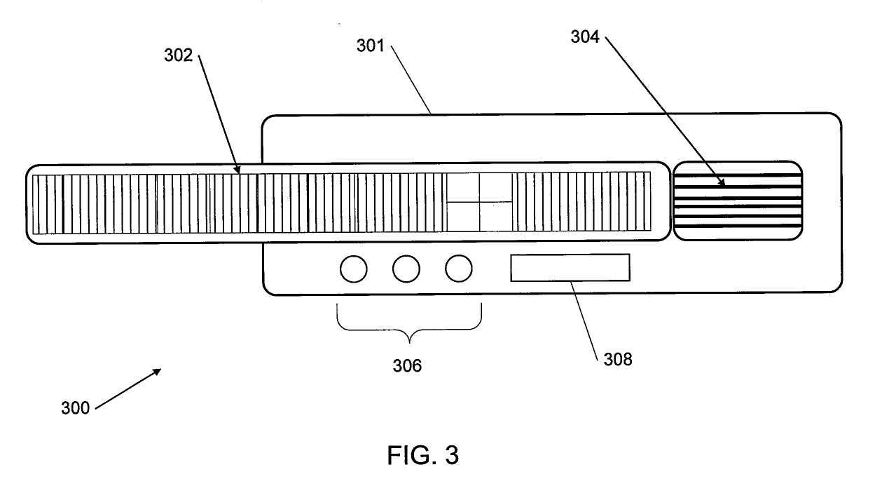

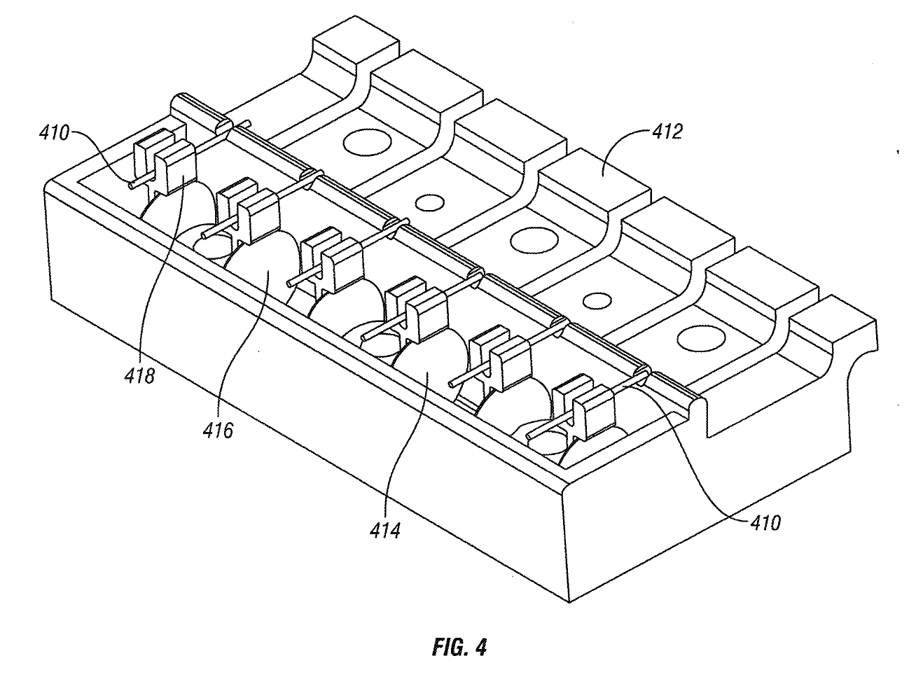

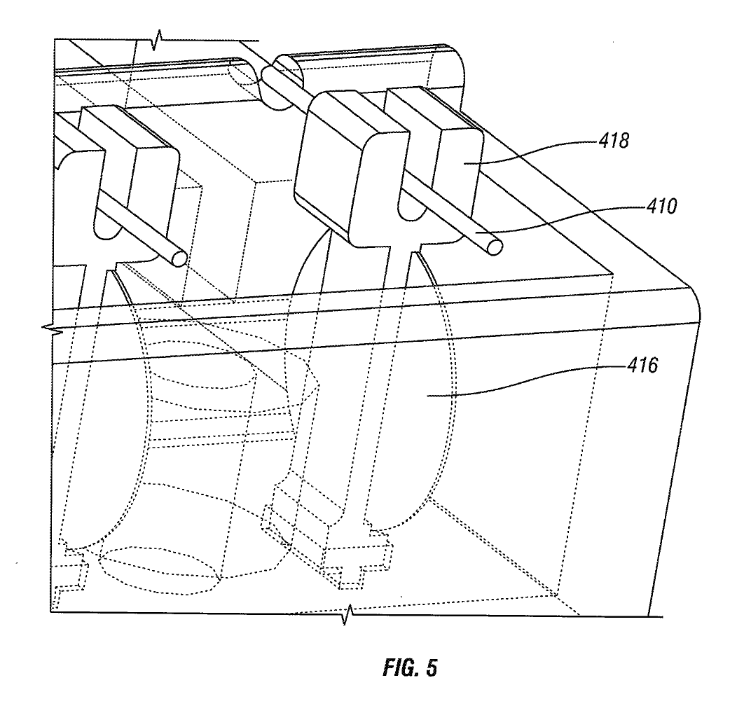

An electronic musical instrument in accordance with the invention can be provided with strings for stringed playing in combination with the electronic transducers described above. For example, the instrument may be provided with two fretboards, one electronic as described thus far, and the second fretboard having actual strings. FIG. 3 illustrates a musical instrument embodiment 300 with such dual construction, having a body 301 with an electronic fretboard area 302 as described previously and a stringed fretboard area 304. The fretboard area is provided with an overlay or template that provides tactile feedback, such as the overlay material 202 illustrated in FIG. 2. If desired, the stringed fretboard 304 can be provided with piezoelectric transducers with strings that cause vibration of piezo disk sensors. Such a construction is illustrated in FIG. 4 and FIG. 5. Each guitar string 410 is held at one end by a string anchor housing 412 and is associated with a piezo sensor 414 that detects movement of the string, such as plucking or strumming. The piezo sensor 414 includes a piezo element 416 and a piezo disk holder 418, illustrated in greater detail in FIG. 5.

The hybrid-construction musical instrument of FIG. 3 can also be provided with control input switches for adjustment of processing as described herein, such as the control knobs and switches 112, 114, 116, 118, 120 illustrated in FIG. 1. The hybrid-construction embodiment can be provided with control input switches 306 for adjustment of processing as described herein, and can be provided with a user interface display 308 for presenting menu options and confirming device status. Thus, the switches 306 may provide the functionality such as the control knobs and switches 112, 114, 116, 118, 120 illustrated in FIG. 1.

### TOUCHSCREEN-BASED VIRTUAL FINGERBOARD EMBODIMENT

In another embodiment, illustrated in FIG. 6, an electronic musical instrument 600 in accordance with the invention includes a body 601 with a touchscreen-based fully programmable fingerboard system that allows a graphic representation of any type of key or note layout including a 6-string guitar, 4-string bass, piano, clarinet, flute, or other wind instrument key and fingering patterns, or any layout as small as one large key over the entire touch-screen area to as many keys as are practically visible on the touchscreen. In this way, key layouts may change dynamically and may have various backgrounds that display information other than key-locations, such as a musical staff, numeric, text or graphic displays of pertaining data, or simply decorative imagery. The touchscreen may be provided in a variety of technologies. For example, the touch-screen may be provided as an LCD-type touchscreen panel, and may have a resistive or capacitive detecting mechanism, as will be known to those skilled in the art.

In the touchscreen embodiment, the array of “keys” or “switches” previously described is provided as a touchscreen, which as used herein provides an array of homogeneous keys or switches, by virtue of detecting the (x, y) grid location of a physical press against the upper surface of the touchscreen. As with the previously described embodiment, an area of the electronic instrument comprises homogeneous keys or switches of the same type, providing an array of electrical switches (transducers) aligned on the body of the instrument and configured to provide a desired instrument layout, and to provide tactile feedback for playing, while having different playing functions. For example, part of the touch-screen area provides a fretboard area, and part of the same touch-screen area provides a soundboard area.

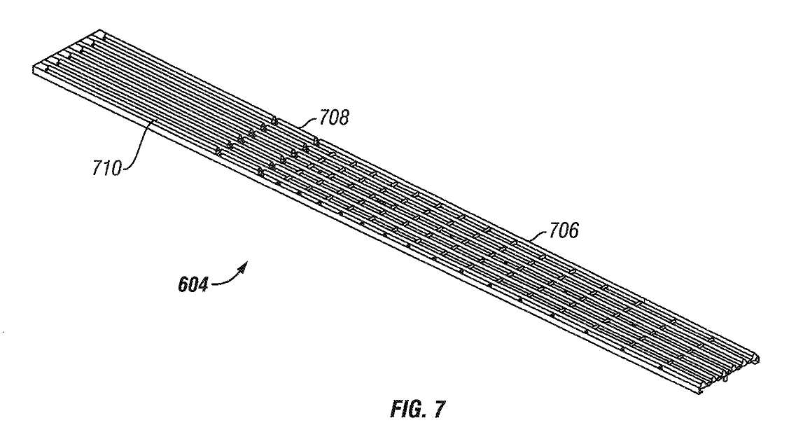

FIG. 6 shows an exemplary embodiment of a musical instrument 600 having a guitar-like body 601 with a touchscreen panel 602. The touchscreen implementation may include a template or overlay that provides tactile feedback for the user. For example, a fretboard pattern can be installed over the touch screen area to provide ridges for the location of frets and thereby permit a more realistic playing experience for the user. The FIG. 6 exemplary embodiment of a musical instrument 600 with the touchscreen panel 602 also includes a template 604 installed over the touchscreen area to provide exemplary subset zones 606, 608, 610 and thereby provide tactile feedback to the user as the instrument “strings” (physically defined by the template 604) are played. FIG. 7 shows the template 604 as defining the three subset zones, comprising a fretting zone 706, a sensor zone 708, and a strumming or triggering zone 710. As noted above, the touchscreen template can be provided with a curved underside along the key “switches” so that vertical pressure and sideways bending motion are both detected.

The touchscreen musical instrument 600 can also be provided with control input switches 612 for adjustment of processing as described herein, as well as a user interface display 614 for presenting menu options and confirming device status. The switches may provide the functionality such as the control knobs and switches 112, 114, 116, 118, 120 illustrated in FIG. 1.

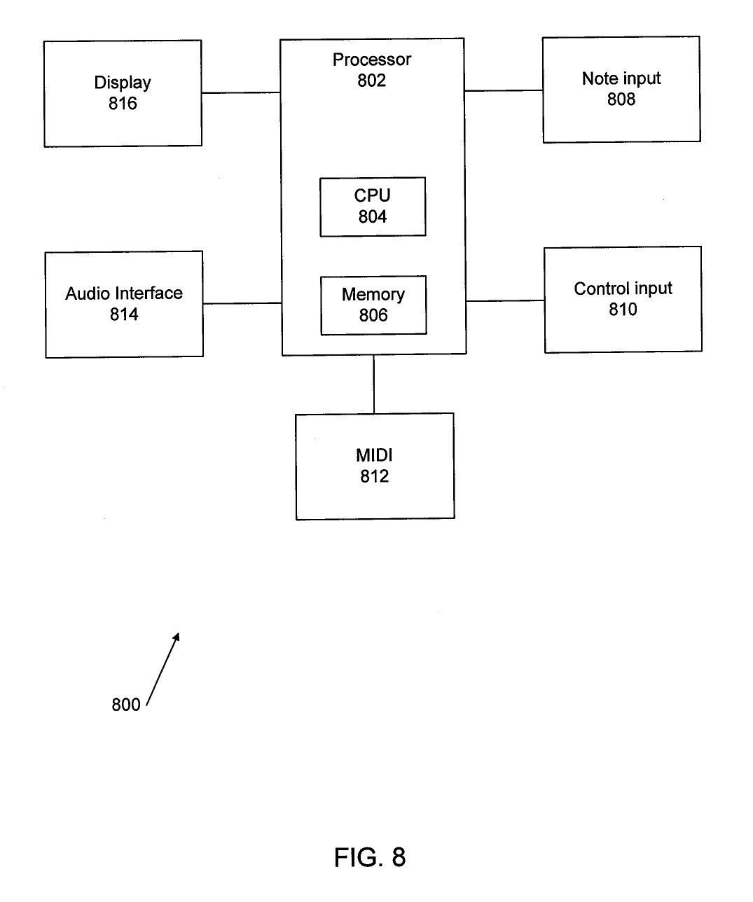

FIG. 8 is a block diagram of an electronic musical instrument 800 constructed in accordance with the principles of the invention. The instrument 800 includes a processor 802 that controls processing and output of note information. The processor includes a central processor unit (CPU) 804 and memory 806. Other components necessary for processing in accordance with the description herein will be known to those skilled in the art. The processor 802 receives note input information 808 from a user pressing the switch array, such as pressing on the switches 102, 104, 106 illustrated in FIG. 1, or the switch area 302 of FIG. 3, or the touchscreen panel 602 of FIG. 6. The construction of the switch array provides tactile feedback useful in “playing” the desired notes. The tactile feedback may be provided, for example, with an overlay such as illustrated in FIG. 2 and FIG. 7.

That is, the user note input information is received from a homogeneous switch array in response to a user pressing the switch array, and from the homogeneous array, the processor 802 produces dissimilar note input data defined over a plurality of musical functions, such as the fretboard, sensor, and soundboard input described herein. The processor determines the appropriate musical functions in accordance with the function assigned to the switch portion from which the user input was received. The processor 802 can also receive control input 810 from other input switches, such as the control knobs and switches 112, 114, 116, 118, 120 illustrated in FIG. 1 and control input 612 in FIG. 6.

The electronic musical instrument 800 produces MIDI output comprising note information in accordance with the Musical Instrument Digital Interface standard. The note data for the MIDI event information is produced by the processor 802 and provided to the MIDI output interface component 812, which interfaces to MIDI-compatible devices through a MIDI output connector. The MIDI-compatible devices then produce the musical data from which sound may be generated. The other illustrated embodiments described herein also produce MIDI output. If desired, the processor 802 can produce other electronic musical output, such as audio output 814 through audio-out connectors, or through loudspeakers that can be provided with the instrument 800. The musical instrument 800 also includes a display 816, such as the LCD display 110 described in conjunction with FIG. 1, for the user interface of the instrument. The user interface may permit a user to redefine, modify, or assign functionality of the switches of the note input 808, in conjunction with the control input 810. That is, the function assigned to the input switch portions or subsets can be changed by the user through the user interface, which is accessed through the display and the control input switches.

The processor 802 may be programmed with instructions that, when executed, provide the functionality for the operations described herein. The instructions may be stored in the memory 806 as software programs for execution by the CPU 804. For example, the instructions may be provided as firmware for the device 800.

When the processor 802 executes the operational instructions, it receives input from the user either as control input or note input. The control input is received for modifying operation of the musical instrument 800, such as adjusting the processing that is performed in response to user activation of the keys. The control input comprises user activation or adjustment of the control switches, such as the switches 112, 114, 116, 118 illustrated in FIG. 1, switches 306 in FIG. 3, and switches 612 in FIG. 6. The note input is received for generating musical output, such as MIDI information. The note input comprises user activation of the note keys, such as the keys 102, 104, 106 illustrated in FIG. 1, keys 302 in FIG. 3, and keys 606, 608, 610 in FIG. 6.

The electronic musical instrument 800 can store multiple arrangements of control settings to give the instrument multiple “sounds” or personalities. For example, it may be desired to select different control settings to produce better sound for different musical genres, or to accommodate different playing techniques or styles, or to suit particular songs. With the user interface, a user can set desired zones or portions of the keys for functions such as fretboard, sensor, and the like, as described above. For example, a user may select a fretboard zone for playing notes, input the highest frequency note to be played in the fretboard zone, input the lowest frequency note to be played, and then the instrument may display the string and fret numbers for the zone. The scan mode of a zone may be set between a trigger-on action for playing like a guitar to fret the fretboard zone and strum the trigger zone, or a trigger-off action for tapping notes and playing like a keyboard. Other processing parameters may be selected through the user interface, such as muting zones other than a designated zone, transposing keys in a zone, adjusting key pressure for activation, selecting fixed velocity or touch-sensitive key response, selection of velocity-response curve for the zone, and a unison setting to give all keys in a selected zone the same MIDI pitch value. Thus, the response to the pressing of the keys may be set and adjusted to provide various zones having different function and operation and sound. Such rearrangement of assigned function and operation is more easily accommodated across the keys of the electronic musical instrument because the keys have the same construction.

The present invention has been described above in terms of presently preferred embodiments so that an understanding of the present invention can be conveyed. There are, however, many configurations for musical instruments not specifically described herein but with which the present invention is applicable. The present invention should therefore not be seen as limited to the particular embodiments described herein, but rather, it should be understood that the present invention has wide applicability with respect to musical instruments generally. All modifications, variations, or equivalent arrangements and implementations that are within the scope of the attached claims should therefore be considered within the scope of the invention.

I claim:

1. An electronic musical instrument comprising:
an instrument body;
a homogeneous switch array on the body configured to produce input information defined over a plurality of musical functions in response to pressing of different portions of the homogeneous switch array; and
a processor configured to receive the input information from the homogeneous switch array and produce musical note information output such that the musical note information output conforms to a musical function assigned to the different portions;
wherein the homogeneous switch array provides tactile feedback for playing.

2. The electronic musical instrument of claim 1, wherein the homogeneous switch array includes independently playable switches.

3. The electronic musical instrument of claim 1, wherein the homogeneous switch array comprises a touchscreen panel.

4. The electronic musical instrument of claim 3, further including an overlay that physically defines the different portions over which the musical functions are assigned.

5. The electronic musical instrument of claim 1, further including at least one control input switch through which the musical functions are modified.

6. The electronic musical instrument of claim 1, further including a stringed musical instrument portion on the instrument body.

7. The electronic musical instrument of claim 1, wherein the musical note information is provided to a MIDI output interface.

8. The electronic musical instrument of claim 1, wherein the assigned musical function of at least one portion of the switch array comprises a fretboard.

9. The electronic musical instrument of claim 1, wherein the assigned musical function of at least one portion of the switch array comprises a hotkey zone providing at least one function select key.

10. The electronic musical instrument of claim 1, wherein the assigned musical function of at least one portion of the switch array comprises a sensor zone providing at least one expression pad key.

11. The electronic musical instrument of claim 1, wherein the assigned musical function of at least one portion of the switch array comprises a harp zone providing at least one musical chord play key.

12. The electronic musical instrument of claim 11, further including multiple portions having an assigned musical function of the harp zone, such that multiple musical chords can be played simultaneously in accordance with activating the multiple portions.

13. The electronic musical instrument of claim 1, wherein the processor receives user input to provide programmable musical chord play initiated from pressing a single switch of the switch array.

14. The electronic musical instrument of claim 1, wherein the processor provides a stepped arpeggiator function such that the processor responds to a plurality of note presses of the homogeneous switch array by producing corresponding notes in a stepped-pattern that is repeated in a cycle according to order of entry of the notes.

15. The electronic musical instrument of claim 1, wherein the processor provides a single-key retrigger event to at least one portion of the homogeneous switch array.

16. The electronic musical instrument of claim 1, wherein:
the homogeneous switch array detects sideways pressure applied to each switch of the array; and
the processor adjusts the musical note information output in response to the detected sideways pressure.

17. A method of processing user input of an electronic musical instrument, the method comprising:
receiving input information from a homogeneous switch array of the electronic musical instrument, wherein the homogeneous switch array is configured to produce input information defined over a plurality of musical functions in response to pressing of different portions of the homogeneous switch array and is configured to provide tactile feedback for playing; and
producing musical note information output in response to the received input information such that the musical note information output conforms to a musical function assigned to the different portions.

18. The method of claim 17, further including modifying the musical functions that are defined over the different portions of the homogeneous switch array.

19. The method of claim 17, further including producing MIDI output in response to the musical note information.

20. The method of claim 17, wherein the assigned musical function of at least one portion of the switch array comprises a fretboard.

21. The method of claim 17, wherein producing musical note information includes responding to an assigned function of at least one portion of the switch array comprises a hotkey zone providing at least one function select key.

22. The method of claim 17, wherein the assigned function of at least one portion of the switch array comprises a sensor zone providing at least one expression pad key.

23. The method of claim 17, wherein the assigned function of at least one portion of the switch array comprises a harp zone providing at least one musical chord play key.

24. The method of claim 23, wherein the functions are assigned such that multiple portions of the switch array have an assigned function of the harp zone, such that multiple musical chords can be played simultaneously in accordance with activating the multiple portions.

25. The method of claim 17, wherein the processor receives user input to provide programmable musical chord play initiated from pressing a single switch of the switch array.

26. The method of claim 17, further including responding to a plurality of note presses of the homogeneous switch array by producing corresponding notes in a stepped-pattern that is repeated in a cycle according to order of entry of the notes.

27. The method of claim 17, further including responding to a pressing of at least one portion of the homogeneous switch array with a key retrigger event.

28. The method of claim 17, further including
detecting sideways pressure applied to each switch of the homogeneous switch array; and
adjusting the musical note information output in response to the detected sideways pressure.
